(19) United States
(12) Patent Application Publication
(10) Pub. No.: US 2009/0142940 A1
(43) Pub. Date: Jun. 4, 2009

(54) Electrical junction box

(75) Inventor: Naoyuki Ikeda, Kosai (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 12/292,718

(22) Filed: Nov. 25, 2008

(30) Foreign Application Priority Data
Nov. 30, 2007 (JP) 2007-311008

(51) Int. Cl. H01R 12/00

(52) U.S. Cl. 439/76.2

(57) ABSTRACT

The present invention is to provide a miniaturized electrical junction box including a miniaturized circuit board. The circuit board includes a plurality of transistors disposed side-by-side in-line each having a downwardly projecting control terminal, a laterally projecting output terminal, and an input terminal projecting oppositely of the control terminal and the output terminal of the associated transistor. The side-by-side in-line output terminals are oriented outwardly from the circuit board and inserted into a connector housing as connector terminals of a connector. The side-by-side in-line input terminals are connected to bus bars disposed rearward of the transistors for receiving electrical power through the bus bars.

### BACKGROUND OF THE INVENTION

1. Field of the Invention

The present invention relates to an electrical junction box operating as an electrical power distributor, such as a relay box, a fuse box, or an electrical control unit box, to connect a battery with a variety of electrical auxiliaries of a motor vehicle, and especially relates to the electrical junction box including a transistor utilized in place of an electromagnetic relay.

2. Description of the Related Art

The electrical power of the battery is usually supplied to the auxiliaries of the motor vehicle with control of on-off switching of the electromagnetic relay. The electrical junction box generally receives a plurality of the electromagnetic relays and the fuses.

The electromagnetic relay has recently been replaced with a transistor (power MOS FET) in order to achieve miniaturization of the electrical junction box and high-speed switching control (for example, JP H10-126963 A, FIG. 9).

A conventional transistor 100, refer to FIGS. 8A-8D, has an input terminal 111, an output terminal 112, and a control terminal 113, which project from a package 115 of the transistor 100 to the same direction and are solder connected to a circuit board.

Such arrangement of the terminals 112-113 necessitates a circuit pattern on the circuit board in order to connect the transistor with an external electrical part. The input terminal and the output terminal as a power supply line each have the circuit pattern wider than that of the control terminal. When the circuit patterns of these terminals are formed on the single circuit board, the circuit board grows in size, resulting in a large size of the circuit board and the electrical junction box. The large size of the electrical junction box may not be accommodated into a space of the motor vehicle. The circuit pattern including the power line causes a large heat generation and often causes problems such as a solder crack.

### SUMMARY OF THE INVENTION

An object of the present invention is to provide an electrical junction box including a transistor to miniaturize a circuit board and an electrical junction box receiving the circuit board, to reduce heat generation thereof, and to improve quality of the circuit board.

(1) According to a first aspect of the present invention, an electrical junction box includes a circuit board; and a transistor mounted to the circuit board as a relay element, the transistor having a package, a conductive metal input terminal projecting from the package, a conductive metal output terminal projecting from the package, and a conductive metal control terminal projecting from the package and receiving signal for controlling on-off between the input terminal and the output terminal, wherein the control terminal of the transistor is oriented in one way and the output terminal of the transistor is oriented in another way, the control terminal of the transistor being connected to the circuit board, the output terminal of the transistor being an external output terminal of the circuit board.

(2) According to a second aspect of the present invention, an electrical junction box includes a circuit board; and a plurality of transistors mounted to the circuit board as relay elements, the transistors having at least one package, a plurality of conductive metal input terminals projecting side-by-side in the same direction from the package, a plurality of conductive metal output terminals projecting side-by-side in the same direction from the package, and a plurality of conductive metal control terminals projecting side-by-side in the same direction from the package and receiving signal for controlling on-off between the input terminals and the output terminals, wherein the control terminals of the transistors are connected to the circuit board and the output terminals of the transistors are external output terminals of the circuit board.

(3) Preferably, the electrical junction box further includes a connector having a connector housing made of an insulation synthetic resin, wherein the output terminals of the transistors project outwardly from the circuit board, and are received in the connector housing and operable as connector terminals of the connector.

(4) Preferably, the input terminal is connected to a bus bar supplying electrical power.

(5) Preferably, the input terminal of the transistor projects from the package in a direction different from directions of projection of the output terminal and the control terminal, a portion of the input terminal opposite the output terminal being connected to a bus bar disposed rearward of the transistor and supplying electrical power.

(6) Preferably, the transistor is a switch bare chip covered with the package, the bare chip being mounted to a lead frame of a plate-shaped conductive metal and having the output terminal and the control terminal, the lead frame being operable as the input terminal, the package is made of an insulation synthetic resin and integral with the bare chip, and has a first, a second, a third and a fourth side each having a rectangular shape when viewed from side, and the control terminal projects from the first side of the package, the output terminal projects from the second side adjacent the first side, and the input terminal projects and extends L-shaped outwardly from the third side and the fourth side opposite the first side and the second side, respectively.

(7) Preferably, the transistor is disposed on an edge portion of the circuit board.

According to the electrical junction box having the configuration of (1) and (2), the control terminal of the transistor is connected to the circuit pattern on the circuit board and the output terminal is oriented away from the circuit board. The output terminal can be adapted to an external output terminal of the electrical junction box without intervening the circuit board. The conventional transistor has a control terminal and an output terminal projecting in the same direction and connected to a circuit pattern on a circuit board. The output terminal of the conventional transistor is connected to the external output terminal with a power line of the circuit pattern on the circuit board. The power line has a size larger than a signal line and the circuit board thus grows in size. The transistor of the present invention eliminates the power line of the circuit pattern and thus miniaturizes the circuit board and also the electrical junction box receiving the circuit board. Miniaturization of the circuit board reduces solder crack and improves quality of the circuit board. Elimination of the power line of the circuit pattern between the output terminal of the transistor and the external output terminal reduces heat generation of the circuit board and reduces a number of parts interconnecting therebetween.

According to the electrical junction box having the configuration of (3), it is appreciated that the output terminal of the transistor is received in the connector housing without interconnection parts and adapted to the connector terminal of the connector.

According to the electrical junction box having the configuration of (4), it is appreciated that electrical power is supplied to the output terminal through the bus bar without intervening the circuit board. A plurality of the output terminals allow distribution of the electrical power. The conventional transistor has the power line of the circuit pattern on the circuit board connecting the electrical power supply with the input terminal of the transistor. The power line has a pattern width larger than that of a signal line and the circuit board thus grows in size. Elimination of the circuit pattern of the power line miniaturizes the circuit board and also the electrical junction box receiving the circuit board, reduces solder crack and improves quality of the circuit board. A cross-sectional size of the bus bar is suitably designed compared with the circuit pattern of the circuit board so as to improve heat dissipation of the transistor through the bus bar.

According to the electrical junction box having the configuration of (5), it is appreciated that the electrical power supplied through the bus bar can be supplied to the output terminal through the transistor without intervening the circuit board. The electrical power can be distributed to the plurality of the output terminals. The conventional transistor has the control terminal, the output terminal and the input terminal projecting in the same direction, and connected to the circuit pattern on the circuit board. The transistor of the electrical junction box having the configuration of (5) has the input terminal and the output terminal oriented away from the circuit board and the input terminal projects oppositely of the output terminal. The input terminal of the conventional transistor is connected with the electrical power supply via the power line of the circuit pattern. The power line has the pattern width larger than that of the signal line and increases the size of the circuit board. The transistor of the electrical junction box having the configuration of (5) eliminates the power line of the circuit pattern, and the elimination of the power line miniaturizes the circuit board and also the electrical junction box receiving the circuit board. The decrease in size of the circuit board reduces solder crack and improves quality of the circuit board. The elimination of the power line of the circuit pattern reduces heat generation of the circuit board. The cross-sectional size of the bus bar of (5) is suitably designed compared with the circuit pattern in order to improve heat dissipation of the transistor mostly via the bus bar.

According to the electrical junction box having the configuration of (6), the output terminal is positioned perpendicularly to the control terminal and extends parallel to the circuit board, and the input terminal is disposed oppositely of the output terminal and the control terminal. A plurality of the transistors are disposed side-by-side on the circuit board in order that the output terminals and the input terminals are also positioned side-by-side. The side-by-side output terminals are disposed parallel to the circuit board and received in the connector housing so that the output terminals operate as connector terminals of a connector. This configuration reduces a number of terminal parts and simplifies the design thereof. The lead frame as the side-by-side input terminals disposed oppositely of the output terminals are easily connected to the single bus bar. The electrical power supplied via the bus bar can thus be supplied through the transistors to the connector terminals without intervening the circuit board. The bus bar and the outwardly projecting L-shaped input terminals improve heat dissipation of the transistors.

According to the electrical junction box having the configuration of (7), the output terminal of the transistor is disposed parallel to the circuit board and extends outwardly from the edge portion of the circuit board so that the output terminal operates as the external output terminal without intervening the circuit board.

When the connector having the connector housing, which receives the output terminals of the transistor as the connector terminals, is disposed on the edge portion of the circuit board, the electrical power is easily supplied from the output terminals to the mating terminals connected to the connector.

The present invention achieves miniaturization of the circuit board and the electrical junction box receiving the circuit board, and reduces heat generation and solder crack, resulting in improvement of quality of the circuit board.

### BRIEF DESCRIPTION OF THE DRAWINGS

FIG. 1A is a front view of a transistor utilized in an embodiment of an electrical junction box of the present invention;

FIG. 1B is a side view of the transistor when viewed from an output terminal (source terminal);

FIG. 2 is an exploded perspective view of the electrical junction box including the transistors of FIG. 1;

FIG. 3 is a perspective view of an assembled electrical junction box of FIG. 2;

FIG. 4 is a perspective view of a circuit board unit assembled into the electrical junction box of FIG. 3;

FIG. 5 is an exploded perspective view of an electrical junction box having a size larger than that of the electrical junction box of FIG. 3;

FIG. 6 is a perspective view of a circuit board unit showing an essential portion of a first alteration of the embodiment of the electrical junction box;

FIG. 7A is a front view of a transistor showing an essential portion of a second alteration of the embodiment of the electrical junction box of the present invention;

FIG. 7B is a side view of the transistor when viewed from an output terminal (source terminal) of the transistor of FIG. 7A;

FIG. 8A is a front view of a conventional transistor;

FIG. 8B is a top view of the conventional transistor;

FIG. 8C is a side view of the conventional transistor; and

FIG. 8D is a bottom view of the conventional transistor.

### DETAILED DESCRIPTION OF THE PREFERRED EMBODIMENTS

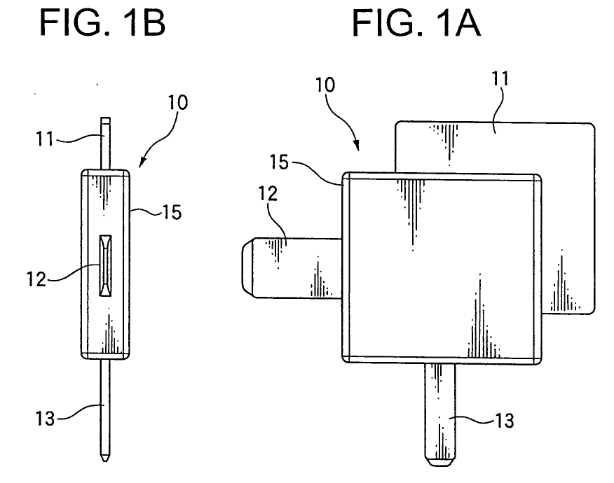

FIGS. 1A and 1B are external views of a transistor utilized in an electrical junction box of an embodiment of the present invention. The transistor 10 is a power MOSFET, and has a conductive metal input terminal (drain terminal) 11, a conductive metal output terminal (source terminal) 12, and a conductive metal control terminal (gate terminal) 12 to receive signal for controlling on-off between the input terminal 11 and the output terminal 12. These terminals 11-13 project outwardly from a package 15 of the transistor 10, the package 15 being made of an insulation synthetic resin. The control terminal 13 and the output terminal 12 project in directions perpendicular one another, and the input terminal 11 projects in a direction opposite the directions of projections of the output and the control terminal 12, 13.

The transistor 10 is a switch bare chip covered with the package 15, the bare chip being mounted on a lead frame of a plate-shaped conductive metal and having the output terminal 12 and the control terminal 13, the lead frame being operated as the input terminal 11. The package 15 is formed with insert mold of the bare chip held with a die in order to form a first, a second, a third and a fourth side each having a rectangular shape when viewed from side. The control terminal 13 projects from the first side (lower side) and the output terminal 12 projects from the second side (left side) adjacent the first side. The lead frame as the input terminal 11 projects and extends L-shaped outwardly from the third side (upper side) and the fourth side (right side) opposite the first and the second side.

Referring to FIG. 4, a plurality of the transistors 10 as described above are mounted side-by-side to a circuit board 21 in an embodiment so that the control terminals 13 of the transistors 10 project to the same direction and are connected to a circuit pattern on the circuit board 21, the output terminals 12 are oriented parallel to the circuit board 21 and perpendicular to the control terminals 13, and the input terminals 11 are oriented away from the control terminals 13 and the output terminals 12.

When the transistors 10 are mounted to the electrical junction box instead of mechanical relays, the output terminals 12 of the transistors 10 each can be an external output terminal from the circuit board 21 or the electrical junction box without intervening the circuit board 21.

The embodiment explains below that the output terminals 12 of the transistors 10 are fitted into a connector as the external output terminals.

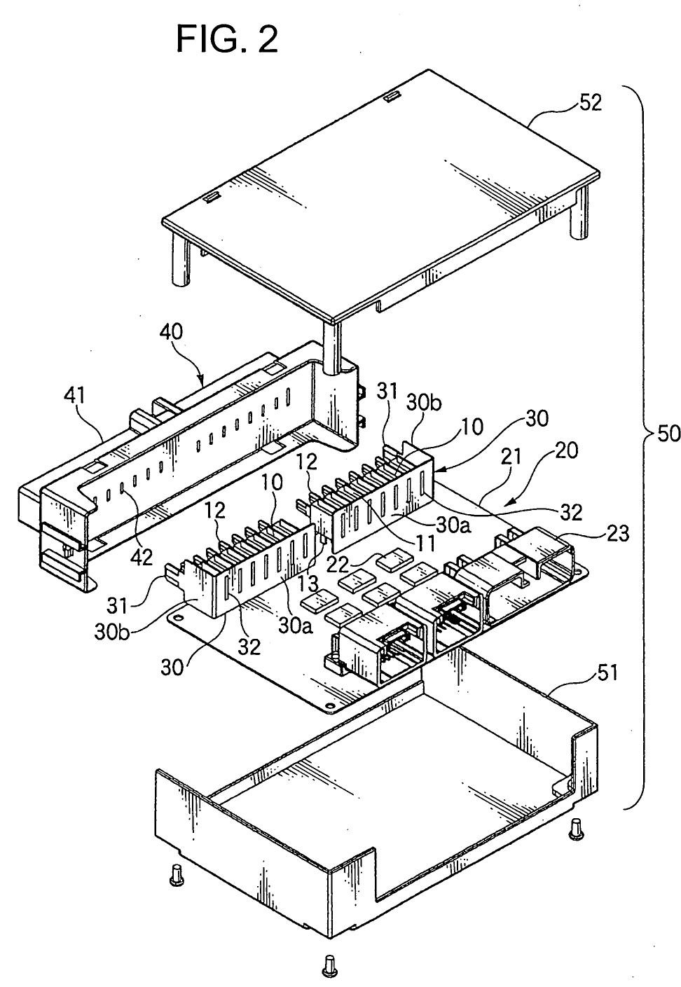

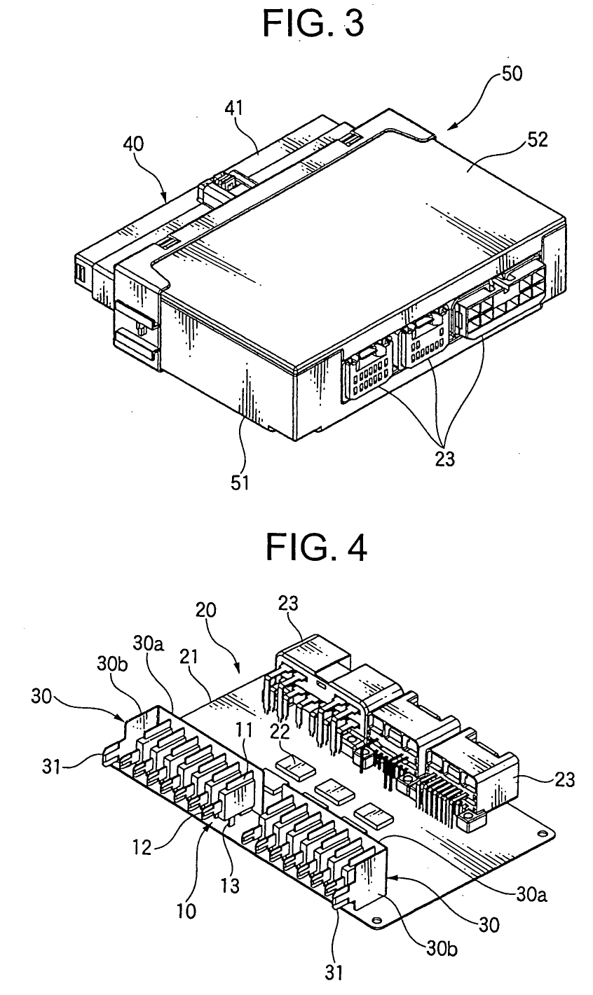

FIGS. 2-4 show a construction of the electrical junction box 50 having the circuit board 21 including the plurality of the transistors 10 as the relay elements. FIG. 2 is an exploded perspective view of the electrical junction box 50, FIG. 3 is an external perspective view of the assembled electrical junction box 50, and FIG. 4 is a perspective view of a circuit board unit 20 received in the electrical junction box 50.

Referring to FIGS. 2 and 4, the circuit board unit 20 includes the rectangular circuit board 21 mounted with electronic devices 22 such as integrated circuits, a couple of the (seven) transistors 10 disposed side-by-side in-line on one edge portion (longer side) of the circuit board 21, two bus bars 30 each upstanding behind the couple transistors 10 to supply electrical power, and a plurality of connectors 23 disposed on another longer side of the circuit board 21.

The bus bars 30 are made of a conductive metal and upstanding from the circuit board 21, and each have a main plate 30a disposed rearward of the associated couple transistors 10, a side plate 30b extending forwardly from the main plate 30a, and a power supply input terminal 31 projecting forwardly from the side plate 30b.

As shown in FIGS. 2 and 4, the transistors 10 are supported with the control terminals 13 connected to the circuit pattern of the circuit board 21. The output terminals 12 of the transistors 10 are in-lined and oriented outwardly from the circuit board 21, and the power supply output terminals 31 of the bus bars 30 are each disposed outside of the output terminal 12 positioned outermost. The input terminals 11 positioned opposite the output terminals 12 are also in-lined. The input terminals 11 are solder-connected to holes 32 of the main plates 30a of the bus bars 30.

The electrical junction box 50 is assembled in a manner as shown in FIGS. 2 and 3 that the circuit board unit 20 is attached to a lower case 51 and an upper cover 52 is covered to the lower case 51 and a connector housing 41 made of an insulation synthetic resin is attached to a front opening defined by the lower case 51 and the upper cover 52. The output terminals 12 of the transistors 10 and the power supply input terminals 31 of the bus bars 30 are inserted through terminal insertion holes 42 into cavities of the connector housing 41. The output terminals 12 and the power supply input terminals 31 operate as connector terminals of a connector 40.

The electrical junction box 50 is formed such that the control terminals 13 of the transistors 10 are connected to the circuit pattern on the circuit board 21, and the output terminals 12 of the transistors 10 are oriented away from the circuit board 21 and operate as the external output terminals of the electrical junction box 50 without intervening the circuit board 21.

The conventional transistor has the control terminal and the output terminal projecting to the same direction and connected to the circuit pattern on the circuit board. The output terminals 12 of the transistors 10 of the electrical junction box 50 are oriented away from the circuit board 21 so that the output terminals 12 can be adapted to the external output terminals.

The output terminals of the conventional transistors are connected to the external output terminals through the circuit pattern of the circuit board with the power lines each having a pattern width wider than the signal line, resulting in that the circuit board grows in size. The transistors 10 of the electrical junction box 50 eliminate the circuit pattern of the power lines, and the circuit board and the electrical junction box 50 receiving the circuit board 21 can thus be miniaturized. Miniaturization of the circuit board 21 reduces the soldering crack and improves reliability thereof.

Elimination of the circuit patterns of the power lines connecting the output terminals of the transistors 10 with the external output terminals on the circuit board reduces heat generation of the circuit board. The direct connection between the output terminals 12 of the transistors 10 and mating terminals reduces circuit member interconnecting therebetween.

The output terminals 12 of the transistors 10 are received in the connector housing 41 made of the insulation synthetic resin and operate as the connector terminals of the connector 40, so that the connection members can be eliminated and the construction can be simplified.

The electrical junction box 50 includes the transistors 10 having the input terminals 11 oriented away from the control terminals 13 and the output terminals 11 and rearwardly connected to the bus bars 30 supplying the electrical power. The electrical power is thus supplied to the output terminals 12 of the transistors 10 through the bus bars 30 without intervening the circuit board 21.

The conventional transistors have the control, the output, and the input terminals projecting to the same direction and connected to the circuit pattern on the circuit board. The input terminals 11 of the transistors 10 of the electrical junction box 50 are oriented away from the circuit board 21 and are positioned opposite the output terminals 12. The conventional transistors are energized with the electrical power supply through the power lines of the circuit pattern on the circuit board. The power lines each have the pattern width larger than that of the signal line and the circuit board thus grows in size. The transistors 10 of the electrical junction box 50 eliminate the power lines of the circuit pattern and thus miniaturize the circuit board 21 and the electrical junction box 50.

The miniaturization of the circuit board 21 reduces solder crack and increases quality of the circuit board 21. The elimination of the power lines of the circuit pattern on the circuit board 21 between the electrical power supply and the input terminals 11 of the transistors 10 reduces heat generation of the circuit board 21. The cross-sectional size of the bus bars 30 is optionally designed compared with the circuit pattern on the circuit board 21 and heat generated at the transistors 10 can thus be effectively dissipated through the bus bars 30.

The electrical power is supplied to the input terminals 12 of the connector 40 through the L-shaped input terminals 11 upwardly rearwardly projecting from the packages 15 without intervening the circuit board 21 so as to improve heat dissipation by means of the bus bars 30 and the input terminals 11.

The output terminals 12 of the transistors 10 of the electrical junction box 50 are disposed side-by-side in-line on the edge portion of the circuit board 21 and projected outwardly from and parallel to the circuit board 21, so that the electrical power can be easily supplied from the output terminals 12.

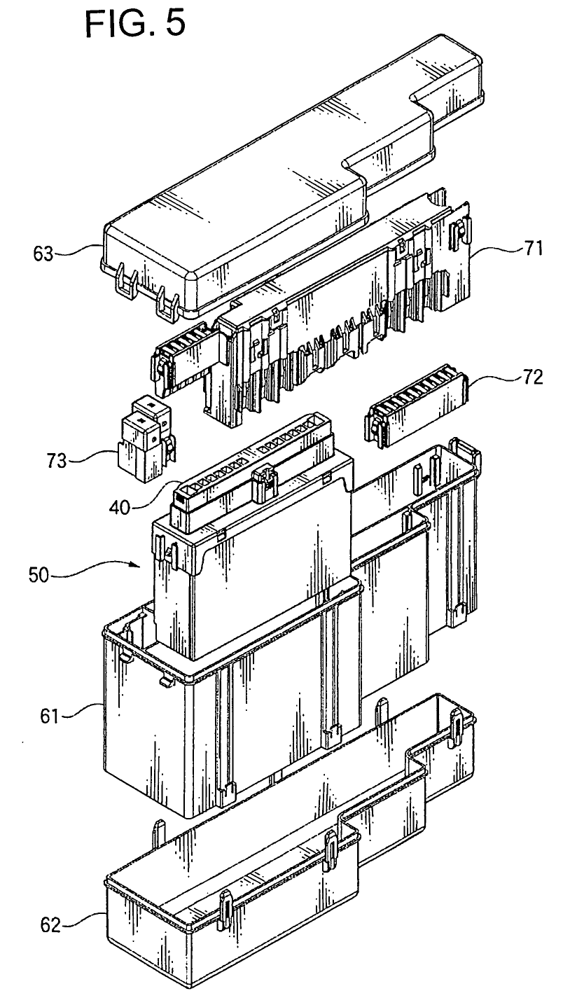

Referring to FIG. 5, the electrical junction box 50 is assembled into a main body 61 with other parts 71-73 and covered with a lower cover 62 and an upper cover 63.

The present invention is not limited to the embodiment described above, and any modification and alteration are possible within the scope of the present invention.

First Alteration:

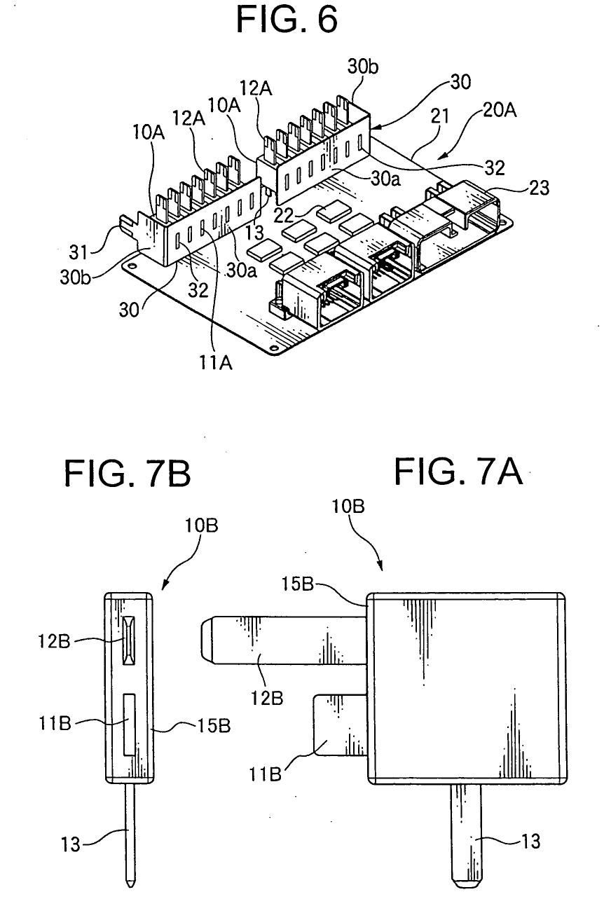

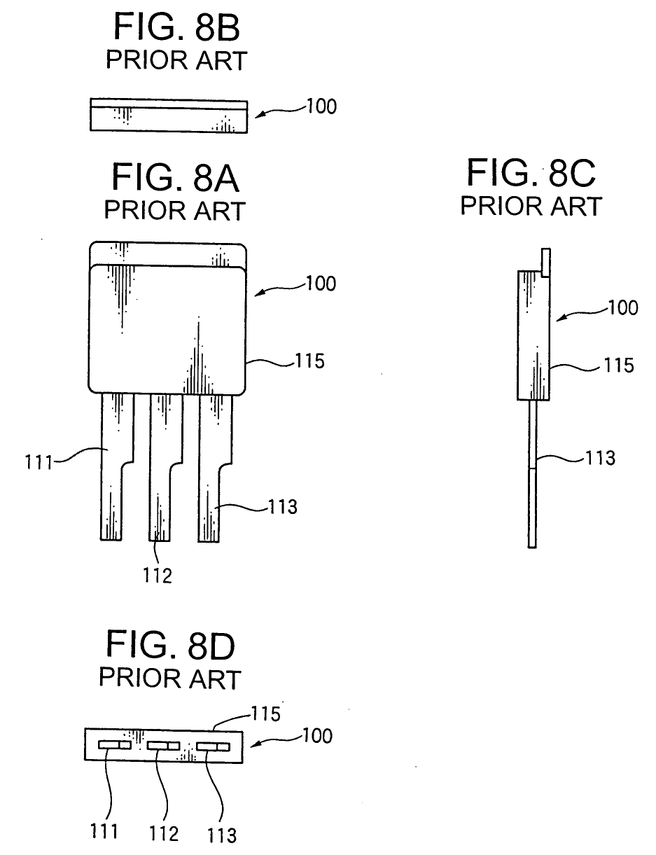

FIG. 6 is a perspective view of an essential portion of a circuit board unit 20A of a first alteration. Like portions as the portions described above have like numerals and explanations thereof are omitted. Referring to FIG. 6, transistors 10A (power MOS FET) of the first alteration utilized in the electrical junction box each have a package made of an insulation synthetic resin, a conductive metal input terminal (drain terminal) 11A projecting from the fourth side of the package (refer to FIG. 1), a conductive metal output terminal (source terminal) 12A upwardly projecting from the third side of the package, and the control terminal (gate terminal) 13 projecting from the first side of the package to receive signal for controlling on-off between the input terminal 11A and the output terminal 12A. The control terminals 13 of the transistors 10A are positioned side-by-side in-line and connected to the circuit pattern of the circuit board 21 and the transistors 10A are in-lined on the circuit board 21. The output terminals 12A are positioned side-by-side in-line and oriented upwardly from the circuit board 21 and the input terminals 11A are thus oriented parallel to the circuit board 21. The input terminals 11A are each solder connected to the hole 32 of the main plate 30a of the bus bar 30 supplying the electrical power. The power supply input terminals 31 of the bus bars 30 each are disposed outside of the output terminal 12A positioned outermost.

Second Alteration:

FIG. 7 is an external view of an essential portion of a transistor 10B of the second alteration. Like portions as the portions described above have like numerals and explanations thereof are omitted. Referring to FIG. 7, the transistor 10B (power MOS FET) of the second alteration utilized in the electrical junction box has a package 15B made of an insulation synthetic resin, a conductive metal input terminal (drain terminal) 11B, a conductive metal output terminal (source terminal) 12B, and the control terminal (gate terminal) 13 to receive signal for controlling on-off between the input terminal 11B and the output terminal 12B. The input terminal 11B and the output terminal 12B project from the package 15B in the same direction, and the control terminal 13 projects in a direction perpendicular to the input and the output terminal 11B and 12B. A plurality of the transistors 10B are mounted side-by-side in-line to the circuit board 21 in order that the control terminals 13 are connected to the circuit pattern on the circuit board 21. The input terminals 11B and the output terminals 12B of the transistors 10B are in-lined and oriented in the same direction in order that the input terminals 11B are solder connected into the holes of the conductive metal bus bars supplying the electrical power.

Third Alteration:

It is appreciated that the packages of the transistors can be formed in integral or bonded together such as an integrated circuit. It is apparent that the seven transistors of FIGS. 2 and 4 can be integrated into a single package and the pairs thereof are disposed. It is also apparent that the single package includes the plurality of the transistors.

Fourth Alteration:

The embodiment, the first and the second alteration utilize the plurality of the transistors. It is appreciated that a single transistor can be mounted on the circuit board of the electrical junction box as the relay element.

The transistors are not limited to MOS FET but a bipolar transistor is also adapted.

1. An electrical junction box comprising:
a circuit board; and
a transistor mounted to the circuit board as a relay element, the transistor having a package, a conductive metal input terminal projecting from the package, a conductive metal output terminal projecting from the package, and a conductive metal control terminal projecting from the package and receiving signal for controlling on-off between the input terminal and the output terminal,
wherein the control terminal of the transistor is oriented in one way and the output terminal of the transistor is oriented in another way, the control terminal of the transistor being connected to the circuit board, the output terminal of the transistor being an external output terminal of the circuit board.

2. An electrical junction box comprising:
a circuit board; and
a plurality of transistors mounted to the circuit board as relay elements, the transistors having at least one package, a plurality of conductive metal input terminals projecting side-by-side in the same direction from the package, a plurality of conductive metal output terminals projecting side-by-side in the same direction from the package, and a plurality of conductive metal control terminals projecting side-by-side in the same direction from the package and receiving signal for controlling on-off between the input terminals and the output terminals,
wherein the control terminals of the transistors are connected to the circuit board and the output terminals of the transistors are external output terminals of the circuit board.

3. The electrical junction box as claimed in claim 1, further comprising a connector having a connector housing made of an insulation synthetic resin, wherein the output terminals of the transistors project outwardly from the circuit board, and are received in the connector housing and operable as connector terminals of the connector.

4. The electrical junction box as claimed in claim 1, wherein the input terminal is connected to a bus bar supplying electrical power.

5. The electrical junction box as claimed in claim 4, wherein the input terminal of the transistor projects from the package in a direction different from directions of projection of the output terminal and the control terminal, a portion of the input terminal opposite the output terminal being connected to a bus bar disposed rearward of the transistor and supplying electrical power.

6. The electrical junction box as claimed in claim 5,
wherein the transistor is a switch bare chip covered with the package, the bare chip being mounted to a lead frame of a plate-shaped conductive metal and having the output terminal and the control terminal, the lead frame being operable as the input terminal,
the package is made of an insulation synthetic resin and integral with the bare chip, and has a first, a second, a third and a fourth side each having a rectangular shape when viewed from side, and
the control terminal projects from the first side of the package, the output terminal projects from the second side adjacent the first side, and the input terminal projects and extends L-shaped outwardly from the third side and the fourth side opposite the first side and the second side, respectively.

7. The electrical junction box as claimed in claim 1, wherein the transistor is disposed on an edge portion of the circuit board.

8. The electrical junction box as claimed in claim 2, further comprising a connector having a connector housing made of an insulation synthetic resin, wherein the output terminals of the transistors project outwardly from the circuit board, and are received in the connector housing and operable as connector terminals of the connector.

9. The electrical junction box as claimed in claim 2, wherein the input terminal is connected to a bus bar supplying electrical power.

10. The electrical junction box as claimed in claim 9, wherein the input terminal of the transistor projects from the package in a direction different from directions of projection of the output terminal and the control terminal, a portion of the input terminal opposite the output terminal being connected to a bus bar disposed rearward of the transistor and supplying electrical power.

11. The electrical junction box as claimed in claim 10,
wherein the transistor is a switch bare chip covered with the package, the bare chip being mounted to a lead frame of a plate-shaped conductive metal and having the output terminal and the control terminal, the lead frame being operable as the input terminal,
the package is made of an insulation synthetic resin and integral with the bare chip, and has a first, a second, a third and a fourth side each having a rectangular shape when viewed from side, and
the control terminal projects from the first side of the package, the output terminal projects from the second side adjacent the first side, and the input terminal projects and extends L-shaped outwardly from the third side and the fourth side opposite the first side and the second side, respectively.

12. The electrical junction box as claimed in claim 2, wherein the transistor is disposed on an edge portion of the circuit board.

13. The electrical junction box as claimed in claim 6, wherein the transistor is disposed on an edge portion of the circuit board.

14. The electrical junction box as claimed in claim 11, wherein the transistor is disposed on an edge portion of the circuit board.
